(19) United States
(12) Patent Application Publication
(10) Pub. No.: US 2023/0382632 A1
(43) Pub. Date: Nov. 30, 2023

(54) BIODEGRADABLE TOP MEMBRANE FOR A BEVERAGE CAPSULE

(71) Applicant: SOCIETE DES PRODUITS NESTLE S.A., Vevey (CH)

(72) Inventors: LISE ZEBOUDJ, Neuvecelle (FR); COLIN GARDNER NEILL, Bridgewater, NJ (US); VIOLETTE BOURG, St-Legier (CH)

(21) Appl. No.: 18/246,704

(22) PCT Filed: Oct. 5, 2021
(86) PCT No.: PCT/EP2021/077388

§ 371 Date: Mar. 27, 2023

(30) Foreign Application Priority Data
Oct. 5, 2020 (EP) 20200094.9

(51) Int. Cl. B65D 85/804; B65D 65/46; A47J 31/40; B32B 27/36; B32B 27/08

(52) U.S. Cl. CPC B65D 85/8043; B65D 65/466; A47J 31/407; B32B 27/36; B32B 27/08; B32B 2435/02; B32B 2270/00; B32B 2307/7246; B32B 2250/244; B32B 2307/581; B32B 2439/70; B32B 2307/54; B32B 2307/31

(57) ABSTRACT

The present invention relates generally to the field of beverage capsules. In particular, the present invention relates to a biodegradable top membrane of a beverage capsules. The biodegradable top membrane of a beverage capsule is pierceable by injection means of a beverage preparation machine which are adapted to inject an extraction liquid under pressure inside a closed chamber containing a mass of soluble and/or extractable food material. Remarkably, the top membrane possesses the necessary physical properties to be useful for beverage capsules while being biodegradable. The biodegradable top membrane for a beverage capsule comprises at least one polyhydroxyalkanoate (PHA).

The present invention relates generally to the field of beverage capsules. In particular, the present invention relates to a biodegradable top membrane of a beverage capsule. The biodegradable top membrane of a beverage capsule is pierceable by injection means of a beverage preparation machine which are adapted to inject an extraction liquid under pressure inside a closed chamber containing a mass of soluble and/or extractable food material. Remarkably, the top membrane possesses the necessary physical properties to be useful for beverage capsules while being biodegradable. The biodegradable top membrane for a beverage capsule comprises at least one polyhydroxyalkanoate (PHA).

Beverage preparation machines allow a consumer to prepare at home various types of beverages, for instance coffee-based beverages.

Today, most beverage preparation machines for in-home beverage preparation comprise a system made of a machine which can accommodate portioned ingredients for the preparation of the beverage. Such portions can be soft pods or pads, or sachets, but more and more systems use semi-rigid or rigid portions such as rigid pods or capsules. In the following, it will be considered that the beverage machine of the invention is a beverage preparation machine working with a rigid capsule.

The machine comprises a receptacle for accommodating said capsule and a fluid injection system for injecting a fluid, preferably water, under pressure into said capsule. Water injected under pressure in the capsule, for the preparation of a coffee beverage, is preferably hot, that is to say at a temperature above 70° C. However, in some particular instances, it might also be at ambient temperature. The pressure inside the capsule chamber during extraction and/or dissolution of the capsule contents is typically about 1 to 8 bar for dissolution products (for the dissolution of soluble ingredients like milk powder, chocolate powder, instant coffee or instant tea), and about 2 to 12 bar for extraction of roast and ground coffee.

The principle of extracting and/or dissolving the contents of a closed capsule under pressure is known and consists typically of confining the capsule in a receptacle of a machine, injecting a quantity of pressurized water into the capsule, generally after piercing a face of the capsule with a piercing injection element such as a fluid injection needle mounted on the machine, so as to create a pressurized environment inside the capsule either to extract the substance or dissolve it, and then release the extracted substance or the dissolved substance through the capsule. Capsules allowing the application of this principle have already been described for example in EP1472156 and in EP 1784344 B1. These capsules present the specific features of enclosing the beverage ingredient in a chamber closed by a top membrane through which water is injected and by a bottom membrane configured to be opened further to the increase of water pressure inside the chamber. Upon liquid injection inside the chamber, pressure deforms the bottom membrane until opening elements positioned close to said bottom membrane pierces the deformed membrane, giving way to the beverage prepared inside the chamber towards the outside of the capsule, e.g. into a cup.

As mentioned above, these capsules are rigid capsules usually made of plastic material.

Packaging of manufactured food products is a vital part of the food industry today as it ensures food safety, preserves food quality and plays an important role in production processes, in brand communication and in digitalization. Indeed, several studies show that for a large part of consumers the packaging of a product is one key aspect that drives the purchase decision.

One of the main problems associated with packaging in general is the generation of packaging waste. According to Eurostat in 2017, 172.6 kg of packaging waste was generated per inhabitant in the EU.

The industry addresses this issue by embracing the circular economy. In line with this, the European Commission has recently communicated a new Circular Economy Action Plan (COMMUNICATION FROM THE COMMISSION TO THE EUROPEAN PARLIAMENT, THE COUNCIL, THE EUROPEAN ECONOMIC AND SOCIAL COMMITTEE AND THE COMMITTEE OF THE REGIONS A new Circular Economy Action Plan For a cleaner and more competitive Europe, Brussels, 11.3.2020). Accordingly, the EU needs to accelerate the transition towards a regenerative growth model that gives back to the planet more than it takes, advance towards keeping its resource consumption within planetary boundaries, and therefore strive to reduce its consumption footprint and double its circular material use rate in the coming decade.

One step towards achieving this is to provide sustainable food packaging. Such sustainability can be achieved by recyclable and/or biodegradable food packaging.

The objective of the present invention was it to enrich or improve the state of the art and in particular to provide a biodegradable top membrane for a beverage capsule that has the necessary properties that it can be subjected to heat and pressure during beverage extraction without unwanted deformation or other negative consequences for the beverage preparation, or to at least provide a useful alternative to existing solutions today.

The inventors were surprised to see that the objective of the present invention could be achieved by the subject matter of the independent claims. The dependent claims further develop the idea of the present invention.

In a first aspect, there is provided a capsule according to claim 1.

The capsule comprises a capsule body containing the beverage ingredient, a top membrane, a bottom membrane and an opening device.

The capsule body comprises:
a side wall defining a chamber and extending axially between a top opening and a bottom outlet through which the beverage is dispensed, and
a circumferential annular flange projecting radially outward from the top opening, said flange comprising an upper surface opposite to the chamber with respect to the opening and an opposed lower surface.

Preferably, the capsule body is made of biodegradable or compostable materials, such as polylactic acid (PLA), polyhydroxyalcanoates (PHA), polybutylene succinate (PBS), polybutylene succinate adipate (PBSA), and/or polybutylene adipate terepthalate (PBAT). The top membrane of the capsule is attached to at least a part of the upper surface of the circumferential flange of the capsule body, closes the top opening, and is adapted to be punctured for liquid injection into the capsule.

The top membrane is biodegradable and comprises at least one film of a at least one polyhydroxyalkanoate (PHA).

The bottom membrane of the capsule is provided inside the chamber. With the top membrane, it delimits a beverage ingredient chamber that is filled with a beverage ingredient. This beverage ingredient can be a soluble or extractable beverage ingredient.

The opening device of the capsule provided inside the chamber and below the bottom membrane. It is designed for opening the capsule by relative engagement with the bottom membrane under the effect of a rise in pressure of the injected liquid in the ingredient chamber.

Preferably, this opening device is made of a biodegradable or compostable material.

Preferably the whole capsule is made of a biodegradable or compostable material.

As used in this specification, the words “comprises”, “comprising”, and similar words, are not to be interpreted in an exclusive or exhaustive sense. In other words, they are intended to mean “including, but not limited to”.

The present inventors have shown that a biodegradable top membrane for a beverage capsule, wherein the top membrane comprises at least one polyhydroxyalkanoate (PHA), achieves the objective of the present invention.

The inventors have achieved particularly good results with a top membrane comprising a layer comprising PHA blended with biopolymers and a layer comprising polybutylene succinate (PBS). In one preferred embodiment of the present invention the top membrane comprises a layer comprising PBS sandwiched between two layers comprising PHA blended with biopolymers.

FIG. 4 shows examples of membrane structures of biodegradable top membranes in accordance with the present invention that the inventors have prepared and that achieve the objective of the present invention.

Consequently, the present invention relates in part to a biodegradable top membrane for a beverage capsule comprising at least one polyhydroxyalkanoate (PHA). The biodegradable top membrane is pierceable by injection means of a beverage preparation machine which are adapted to inject an extraction liquid under pressure inside a closed chamber containing a mass of soluble and/or extractable food material. The closed chamber containing a mass of soluble and/or extractable food material may be a part of the beverage capsule or may be the beverage capsule.

The injection means of the beverage preparation machine pierce the top membrane. The injection means may be one or more liquid injection hollow needles, for example. When liquid is injected into the capsule compartment, a pressure is built up, which serves as an extraction means for extracting a mass of soluble and/or extractable food material contained inside the capsule.

PHAs are well-known in the art. PHAs are gaining increasing attention in the biodegradable polymer market due to their promising properties such as high biodegradability in different environments, not just in composting plants, and processing versatility; see for example eXPRESS Polymer Letters Vol. 8, No. 11 (2014) 791-808.

Many PHAs are commercially available. For example, for the top membrane of the present invention, the at least one PHA may be selected from the group consisting of P (3HB-co-3HV), PHB copolymers, P (3HB-co-3HHx), P (3HB-co-4HB), P (3HB), P (3HB-co-3HV), P (3HB-co-3HO), P (3HB-co-3Hod) or combinations thereof.

The biodegradable top membrane may consist of a sealant layer with at least 30% in weight PHA. The inventors have found that this ensures a tight seal during extraction.

If the injection means is withdrawn from the capsule after injecting, for example, hot water into the capsule under pressure, it is essential that the top membrane recloses the piercings caused by the injection means. Otherwise, due to the residual pressure which remains inside the capsule compartment after the capsule has been used, a jet of liquid—often referred to as “whale effect”—can spray out of the capsule top membrane, through the hole pierced by the injection means. Such a whale effect may occur randomly and infrequently, but it is undesirable as it is a potential cause of accidents and lack of cleanliness.

A thick top membrane will prevent this whale effect more effectively than a thin top membrane. On the other hand, a thin top membrane will be faster biodegradable than a thick top membrane.

Preferably, the top membrane is able to withstand, without leaking, a fluid pressure of at least 1 bar, preferably at least 3 bar, more preferably at least 5 bar, after said fluid injection means have been removed therefrom.

The inventors have found that an optimal biodegradability can be ensured while the whale effect can be effectively avoided, if the biodegradable top membrane has a material thickness in the range of about 120 to 150 μm.

On top of the PHA containing layer one or more barrier layers may be added. Further, a print layer may be added, as, for example, many beverage capsules use a coding system to ensure optimal beverage extraction conditions. For example, EP3107433 A1 describes such a coding system.

The top membrane must also withstand a certain pressure during the injection process. For example, in the case of coffee such a beverage extraction machine injects hot water into the capsule under high pressure, and the coffee powder is extracted during a few seconds under high pressure. Hence, the biodegradable top membrane in accordance with the present invention may be able to withstand a pressure of at least 7 bar, at least 9 bar or at least 11 bar. The biodegradable top membrane in accordance with the present invention may be able to withstand such a pressure for a time of at least 5 s, for a time of at least 10 s, or for a time of at least 15 s.

The extraction may be carried out with volume of a fluid, for example water, in the range of about 5-250 ml, for example 10-100 ml. If the extracted beverage is a ristretto, the volume of water may be in the range of 20-30 ml. If the extracted beverage is an expresso, the volume of water may be in the range of 30-50 ml. If the extracted beverage is an expresso double, the volume of water may be in the range of 50-100 ml. If the extracted beverage is a coffee lungo, the volume of water may be in the range of 100-150 ml. During the extraction process a foam layer may be formed in the capsule and on the resulting beverages. For example, the top membrane may be able to withstand the process conditions that allows the generation of an average foam height on the extracted beverage in the range of about 2 and 5 mm, for example in the range of about 3 and 4 mm.

Advantageously, the biodegradable top membrane in accordance with the present invention may comprise an elastic material with a Young's modulus inferior to 150 GPa. Due to the elasticity of the material, the top membrane can be pierced easily and deform when the liquid injection means of the machine are moved through. Then, after the liquid has been injected into the capsule, the injection means is removed therefrom, and the top membrane closes back in a leaktight manner due to its elasticity.

The inventors have achieved particularly promising results when the biodegradable top membrane of the present invention had a multilayer structure, for example, a structure comprising two or more or three or more layers.

For example, the inventors have achieved excellent results when the biodegradable top membrane of the present invention had two layers, for example,
a first layer comprising at least one PHA blended with one or more biopolymers, and
a second layer comprising polybutylene succinate (PBS).

The inventors have further tested successfully additional membrane structures. FIG. 4 shows examples of such membrane structures. Accordingly, the biodegradable top membrane comprising at least one polyhydroxyalkanoate (PHA) in accordance with the present invention can be further adapted to allow further functionalization, such as the possibility to apply reverse printing onto it, and/or to introduce further and/or improved barrier properties. The different layers of the top membrane may be co-extruded. The layers added to allow reverse printing and to improve barrier performance may be laminated. A coating can be applied to avoid sticking to the seal head and to allow a wide temperature processing window.

Accordingly, in the biodegradable top membrane in accordance with the present invention the top membrane may comprise
a PHA blend layer, a PBS layer and a transparent adhesive coating layer,
a PHA blend layer, a PBS layer and a sulfurized paper+adhesive layer,
a PHA blend layer, a PBS layer and a regenerated cellulose+adhesive layer,
a metallized PHA blend layer, a PBS layer and a transparent adhesive coating layer,
a metallized PHA blend layer, a PBS layer and a sulfurized paper+adhesive layer,
a metallized PHA blend layer, a PBS layer and a regenerated cellulose+adhesive layer, a PHA blend layer, a PBS layer, a second PHA blend layer and a transparent adhesive coating layer,
a PHA blend layer, a PBS layer, a second PHA blend layer and sulfurized paper+adhesive layer,
a PHA blend layer, a PBS layer, a second PHA blend layer and a regenerated cellulose+adhesive layer,
a PHA blend layer, a PBS layer, a metallized PHA blend layer and a transparent adhesive coating layer,
a PHA blend layer, a PBS layer, a metallized PHA blend layer and sulfurized paper+adhesive layer, or
a PHA blend layer, a PBS layer, a metallized PHA blend layer and a regenerated cellulose+adhesive layer.

For example, in the biodegradable top membrane in accordance with the present invention the top membrane may comprises from the inside of the beverage capsule to the outside of the beverage capsule
a PHA blend layer, a PBS layer and a transparent adhesive coating layer,
a PHA blend layer, a PBS layer and a sulfurized paper+adhesive layer,
a PHA blend layer, a PBS layer and a regenerated cellulose+adhesive layer,
a metallized PHA blend layer, a PBS layer and a transparent adhesive coating layer,
a metallized PHA blend layer, a PBS layer and a sulfurized paper+adhesive layer,
a metallized PHA blend layer, a PBS layer and a regenerated cellulose+adhesive layer,
a PHA blend layer, a PBS layer, a second PHA blend layer and a transparent adhesive coating layer,
a PHA blend layer, a PBS layer, a second PHA blend layer and sulfurized paper+adhesive layer,
a PHA blend layer, a PBS layer, a second PHA blend layer and a regenerated cellulose+adhesive layer,
a PHA blend layer, a PBS layer, a metallized PHA blend layer and a transparent adhesive coating layer,
a PHA blend layer, a PBS layer, a metallized PHA blend layer and sulfurized paper+adhesive layer, or
a PHA blend layer, a PBS layer, a metallized PHA blend layer and a regenerated cellulose+adhesive layer.

Without wishing to be bound by theory, the inventors presently believe that the PBS layer of biodegradable top membrane in accordance with the present invention contributes to the top membranes ability to withstand high pressures by allowing some elongation without breaking. That it is possible that the biodegradable top membrane in accordance with the present invention can be properly pierced while a leakage at high pressures and high temperatures is avoided of appears to be achieved by the use of PHA and/or PHA blends.

In particular at least the portion of the top membrane adapted to be punctured for liquid injection can present:
a tensile strength higher than 1 MPa, preferably higher than 5 MPa, more preferably higher than 10 MPa, and
an elongation at break superior to 100%, preferably superior to 500%.

Such a top membrane recloses in a leaktight manner, after said fluid injection means have been removed therefrom.

In one preferred embodiment, the top membrane is a multilayer film and this multilayer film comprises at least:
a first layer film of PHA blended with one or more biopolymers, and
a second layer film of at least one polybutylene succinate (PBS).

Usually, the multilayer film comprises a bottom layer film, said bottom layer being configured to be sealed to at least a part of the upper surface of the circumferential flange of the capsule body, and preferably this bottom layer film is different from the second layer film of at least one polybutylene succinate (PBS). Accordingly, it is preferred that the layer comprising PBS is no in contact with the beverage in preparation.

The layer comprising at least one PHA blended with one or more biopolymers may be a sealant layer, for example. The biopolymers may be selected from the group consisting of ethylene vinyl alcohol (EVOH), polyvinyl alcohol (PVOH), ethylene-vinyl acetate (EVA), polysulfone, polyether sulfone, cellulose, cellulose acetate, cellulose acetate butylrate, cellulose triacetate, PLA, PBS, or combinations thereof

The external layer may comprise of or consist of polybutylene succinate (PBS). PBS may be bio-based polybutylene succinate (bioPBS) produced, for example, from the polymerization of bio-based succinic acid and 1,4-butanediol. Onto the external layer a print layer and/or a water vapor transmission (WVT) barrier layer may be applied. The print layer, which may be a paper-based layer, may be applied through lamination. The \ANT barrier layer may be applied through metallization, for example.

The inventors have achieved very good results with a biodegradable top membrane in accordance with the present invention with a thickness of below 150 μm, for example in the range of about 50-150 μm; wherein said top membrane has a sealant layer with a thickness of below 90 μm, for example in the range of about 30-90 μm; and/or with an external layer with a thickness of below 60 μm, for example in the range of about 20-60 μm.

Further, for example, the inventors have achieved excellent results when the biodegradable top membrane of the present invention had three layers, for example:
a bottom layer comprising at least one PHA blended with one or more biopolymers and
an inner layer comprising polybutylene succinate (PBS)
a top layer.

By bottom layer, it is meant the layer attached to the flange of the body capsule and in contact with the beverage in preparation, whereas by top layer, it is means the layer facing the outside of the capsule.

The bottom layer comprising at least one PHA blended with one or more biopolymers may be a sealant layer, for example. The biopolymers may be selected from the group consisting of ethylene vinyl alcohol (EVOH), polyvinyl alcohol (PVOH), ethylene-vinyl acetate (EVA), polysulfone, polyether sulfone, cellulose, cellulose acetate, cellulose acetate butylrate, cellulose triacetate, PLA, PBS, or combinations thereof.

The inner layer may comprise of or consist of PBS or bio-PBS. Onto the inner layer a top print layer and/or a water vapor transmission (VWT) barrier layer may be applied. The print layer, which may be a paper-based layer, may be applied through lamination. The WVT barrier layer may be applied through metallization, for example.

The inventors have achieved very good results with a biodegradable top membrane in accordance with the present invention wherein the biodegradable top membrane had three layers with a total thickness of below 120 μm, for example in the range of about 40-120 μm; wherein said top membrane has a sealant layer with a thickness of below 90 μm, for example in the range of about 30-90 μm; and/or with an internal and/or external layer with a thickness of below 50 μm, for example in the range of about 5-50 μm.

The biodegradable top membrane in accordance with the present invention comprising two or three layers may be co-extruded.

Hence, the biodegradable top membrane in accordance with the present invention may be manufactured by a process comprising the step of co-extruding a layer comprising at least one PHA blended with one or more biopolymers and a layer comprising PBS.

The process may also include a step of laminating a print layer and a V\A/T barrier layer over the layer comprising PBS.

The inventors have achieved excellent biodegradability rates for the biodegradable top membrane in accordance with the present invention. For example, the inventors were able to demonstrate that at least 90 weight-% of the biodegradable top membrane in accordance with the present invention could be biodegrade during 22 days using a dedicated strain for PHA and similar heat conditions than industrial compost.

Hence, the biodegradable top membrane in accordance with the present invention may be compostable, for example compostable under industrial or home composting conditions.

In a second aspect there is provided a system of a capsule such as described above and a beverage preparation machine, said machine comprising a liquid injection hollow needle to inject an extraction liquid under pressure inside or into the chamber

Preferably, the beverage preparation machine of the system comprises:
a capsule holder for receiving and holding the capsule in the beverage preparation machine,
a capsule holder receiving area for inserting the removable capsule holder, and the liquid injection hollow needle and the inserted capsule holder are relatively moveable one to the other so that the liquid injection hollow needle punctures the top membrane of the capsule.

In a last aspect, there is provided the use of a capsule such as described above in this system.

In the present application, the terms “top”, “bottom” are used to describe the relational positioning of features of the invention. These terms should be understood to refer to the capsule in its normal orientation when positioned in the beverage preparation machine for the production of a beverage as shown in the FIGS. 1, 2, 3A, 3B.

Those skilled in the art will understand that they can freely combine all features of the present invention disclosed herein. Features described for the products of the present invention may be combined. Further, features described for different embodiments of the present invention may be combined.

Although the invention has been described by way of example, it should be appreciated that variations and modifications may be made without departing from the scope of the invention as defined in the claims.

Furthermore, where known equivalents exist to specific features, such equivalents are incorporated as if specifically referred in this specification. Further advantages and features of the present invention are apparent from the figures and non-limiting examples.

### BRIEF DESCRIPTION OF THE DRAWINGS

Further features, advantages and objects of the invention will become apparent for the skilled person when reading the following detailed description of embodiments of the invention and when taking in conjunction with the figures of the enclosed drawings. In case numerals have been omitted from a figure, for example for reasons of clarity, the corresponding features may still be present in the figure.

FIG. 1 shows a schematic cross-section of a capsule according to the present invention,

FIG. 2 shows a system of a capsule and beverage preparation machine according to the invention,

FIGS. 3A and 3B are cross section views of the capsule and the capsule holders of FIGS. 1 and 2 in two different operations,

FIG. 4 shows examples of structures of the biodegradable top membrane in accordance with the present invention.

### DETAILED DESCRIPTION OF EXEMPLARY EMBODIMENTS

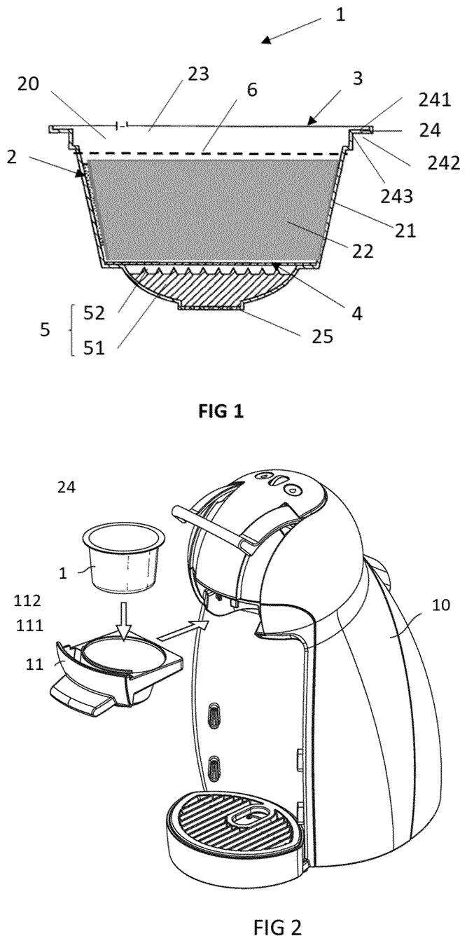

FIG. 1 illustrates schematically a capsule 1 used in the system of the present invention.

The capsule 1 comprises a capsule body 2 with one or more sidewall(s) 22 that extend axially from a bottom towards a top. The sidewall extends towards a top opening 23. At the top opening 23, the body comprises a circumferential flange 24 that extends radially outward from the sidewall and that continuously extend along the circumference of the opening. Usually, the flange 24 is connected with the capsule body by a connecting portion 243. For example, at the connecting portion 243 the sidewall(s) 22 may transition into the flange 24. The flange 24 is usually integrally formed with the one or more side walls 22. The flange comprises an upper surface 241 facing the top and a lower surface 242. The lower surface preferably comprises, or consists of, a flat surface.

Generally, any transversal cross section of the body capsule is circular from the bottom to the top and the flange is circular too as illustrated in the perspective view of FIG. 2.

The sidewall delimits a chamber 21 for containing a soluble and/or extractable beverage ingredient.

This soluble beverage ingredient is a water soluble powder ingredient and can be selected within the list of: instant coffee powder, milk powder, cream powder, instant tea powder, cocoa powder, soup powder, fruit powder or mixture of said powders. The powders can be agglomerated or sintered.

This beverage ingredient packed in the package can also be an ingredient able to be extracted or infused like a roast and ground coffee, or tea leaves. In that embodiment water extracts the beverage ingredient.

The capsule comprises a top membrane 3 that is fixed, sealed or attached to at least a part of the upper surface 241 of the circumferential flange and accordingly covers and closes the top opening 23.

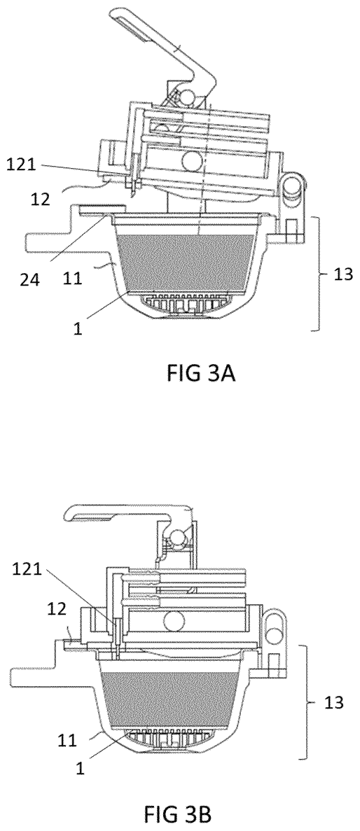

This top membrane is adapted to be punctured for liquid injection into the capsule as illustrated in FIG. 3B. Preferably, the top membrane is pierceable by an injection needle of the beverage preparation machine which is adapted to inject an extraction liquid under pressure inside or into the chamber. Preferably, the puncturing operation is made at one single place by a water injection needle such as described in WO2006/082064 or WO2008/107281.

The term “top membrane” should be understood as the membrane which is pierced by the injection needle of machine, as opposed to the “bottom membrane” (such as described below) which should be understood as the membrane located on the opposite side of the capsule 1.

The capsule comprises a bottom membrane 4 that closes the bottom of the chamber 21. Accordingly, the soluble and/or extractable beverage ingredient is enclosed between the top and bottom membranes. The top and bottom membranes delimit an internal space of the chamber, the ingredient chamber 22, configured to hold the beverage ingredient for the preparation of a beverage.

In one embodiment, a distributor wall 6 can extend through the internal cross section of the chamber defining an inferior sub-chamber for the ingredient and a superior distribution chamber for the liquid. This distributor wall comprises small holes to distribute liquid uniformly on the ingredient.

The capsule comprises an opening device 5 adapted to open the chamber by relative engagement with the bottom membrane 4 under the effect of the liquid pressure increase in the chamber during injection of said liquid. The opening device 5 may comprise a rigid plate 51 comprising opening elements 52 such as spikes, cone- or pyramid-shaped—optionally truncated at their ends—on its surface turned upwardly towards the bottom membrane 4 which may form protrusions and recesses against the bottom membrane 4 facing the opening device. The opening device 5 may be generally referred to as “pyramid plate”. Upon liquid injection inside the chamber 4, pressure builds up, which deforms the bottom membrane 4 against the opening means 5, until the bottom membrane is pierced, giving way to the beverage prepared inside the capsule 1 respectively chamber 21 below the opening device 5. The expression “engagement” may mean that, for instance, the opening device or the second membrane, or alternatively both may be moved with respect to each other to effect opening.

Usually, the capsule body comprises a bottom beverage outlet 25, below the opening device 5. The bottom of the capsule body preferably extends below the opening means to hold said opening means and collect the beverage to this beverage outlet 25 dispensing the beverage outside of the capsule 1, e.g. into a cup.

The top membrane 3 is fixed to the flange 24 in such a way that the extraction liquid injected into the chamber 21 increases internal pressure up to the pressure necessary to obtain the piercing of the deformed bottom membrane 4 by the opening device 5. The top membrane 3 is thus fixed to the flange in such a way that it does not detach at least until a defined pressure inside of the chamber is achieved. This defined pressure may be at least 2 bars, preferably at least 3 bars or at least 6 bars. Thereby, the fixation effects that the capsule 1 does not leak via the interface between the flange and the top membrane during beverage preparation.

Preferably, at least the capsule body 2 and the top membrane 3 are made of compostable materials, even more preferably all the elements of the capsules are made of material(s) and/or contain substances that are (all) compostable.

Usually, the top membrane 3 is attached to the flange 24 by heat sealing, with or without the addition of sealant. Thus, a seal is formed between the top membrane and the flange.

FIG. 2 shows a system of a capsule 1 such as describes above and a beverage preparation machine 10 configured to prepare a beverage from said capsule. The machine comprises a capsule holder 11 removeable from the machine and comprising a receiving area 111 to introduce the body of the capsule while the flange 24 of the body is supported on the circumferential rim 112 of the holder. Then the capsule holder can be inserted in a receiving area 13 of the machine to prepare a beverage.

The machine comprises a capsule holder receiving area 13 for inserting the removable capsule holder where the capsule holder can be inserted to prepare a beverage.

In addition, the machine comprises, above the receiving area 13 for the capsule holder, a liquid injection device 12 with an injection member 121, precisely a hollow needle configured to pierce the top membrane 3 and to inject water inside the capsule. This injection device and the capsule holder are moveable relatively so as to clamp the circumferential annular flange of the capsule.

Then, the capsule holder 11 can be positioned in two positions inside the receiving area 13 as illustrated in FIGS. 3A and 3B.

In FIG. 3A, the capsule holder 11 has just been introduced inside the receiving area 13 and in FIG. 3B, the liquid injection plate 12 is moved to the inserted capsule holder and clamps the circumferential annular flange 24 of the capsule between the circumferential rim 112 of the holder and the injection plate 12.

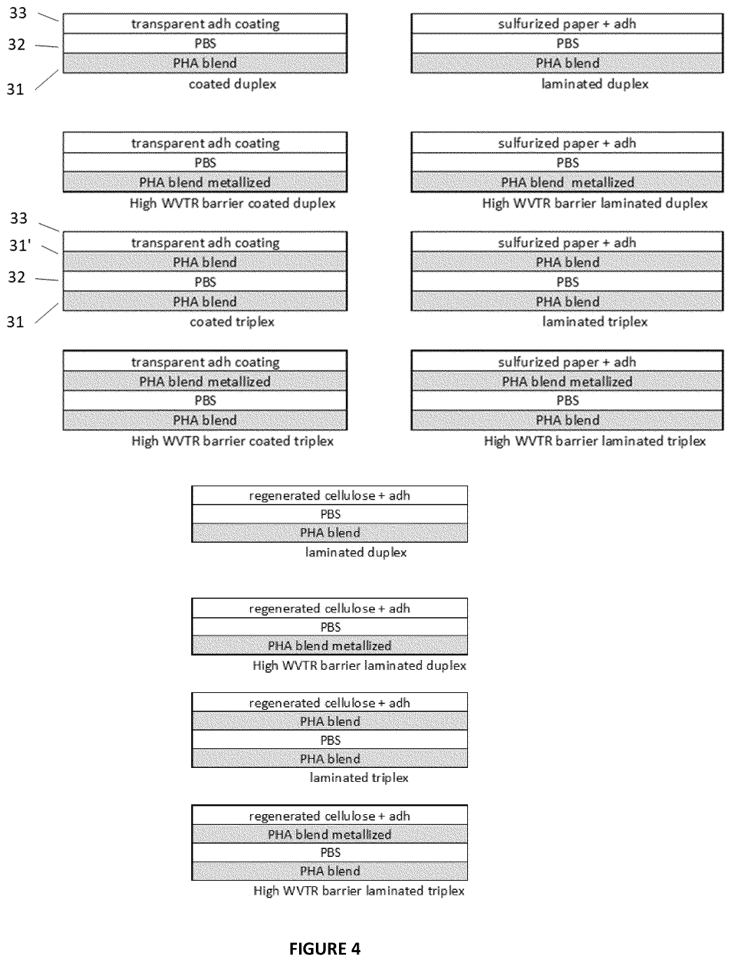

FIG. 4 illustrates structures of the biodegradable top membrane 3 that can be used in the capsule of FIG. 1 and within the system of FIGS. 2A, 2B and 3.

All these top membranes are multilayer films comprising at least:
a first layer film 31 of PHA blended with one or more biopolymers, and
a second layer film 32 of at least one polybutylene succinate (PBS).
a third layer film 33 enabling printing or creating water vapor transmission barrier is provided.

The first layer 31 is attached to the flange of the capsule body and preferably comprises a sealant.

In some embodiments, the top membrane 3 can comprise two first layer film 31, 31′ of PHA blended with one or more biopolymers that surround the second layer at least one PBS.

### Example 1: Extraction of Coffee Beverages

A PHA biodegradable top membrane in accordance with the present invention comprising a PHA blend layer, a PBS layer, and a second PHA blend layer was prepared with a thickness of 150 μm and attached to a beverage capsule such as illustrated in FIG. 1. The body of the capsule was made of PHA. The beverage capsule was filled through the top membrane under high pressure (5-9 bars) with a long time extraction (25-30 seconds) coffee. The samples were prepared as for commercial coffee, including the usage of a heat sealing device to achieve heat sealing. The seal head was protected with a paper so that the top membrane does not stick.

No leak was observed even during beverage preparations with the longest extraction times and the highest pressures.

### Example 2: Resistance to Burst Testing

As the extraction with coffee would bever deliver a pressure above 10 bars, a resistance to burst test was created to check at which pressure the top membrane would detach from the flange of the capsule.

The procedure for such a measurement comprises the following steps: a) placing the capsule to be tested in a bell under airtight conditions; b) introducing compressed air (6 bars) inside the bell and through the hole at the bottom of the capsule and measuring pressure inside the bell; the tested capsule can be empty (no opening means and bottom membrane) or, if there are the opening means and the bottom membrane, the air introduced through the bottom hole pierces easily the bottom membrane or wall; in both of these cases the results in terms of burst resistance of the top membrane are the same; and c) waiting for the bursting of the top membrane and measuring the corresponding pressure.

The results showed that a capsule such as defined in Example 1 with a 150 μm top membrane was able to withstand between 10 bars and 11 bars, while a comparable capsule with a 120 μm top membrane was able to withstand between 7 bars and 9 bars.

1. A capsule for use in a beverage preparation machine, said capsule containing a soluble and/or extractable beverage ingredient and said capsule comprising:
a capsule body comprising:
a side wall defining a chamber and extending axially between a top opening and a bottom outlet,
a circumferential annular flange projecting radially outward from the top opening, said flange comprising an upper surface opposite to the chamber with respect to the opening and an opposed lower surface,
and
a top membrane attached to at least a part of the upper surface of the circumferential flange, said top membrane closing the top opening, and presenting a portion adapted to be punctured for liquid injection into the capsule,
a bottom membrane provided inside the chamber so as to delimit an ingredient chamber between the top membrane and said bottom membrane, said ingredient chamber containing a beverage ingredient,
an opening device provided inside the chamber for opening the capsule by relative engagement of said opening device with the bottom membrane under the effect of a rise in pressure of the injected liquid in the ingredient chamber, and
wherein the top membrane is biodegradable and comprises at least one film of a at least one polyhydroxyalkanoate (PHA).

2. A capsule according to claim 1, wherein the at least one PHA is selected from the group consisting of P (3HB-co-3HV), PHB copolymers, P (3HB-co-3HHx), P (3HB-co-4HB), P (3HB), P (3HB-co-3HV), P (3HB-co-3HO), P (3HB-co-3Hod) and combinations thereof.

3. A capsule according to claim 1, wherein the at least one film of a at least one polyhydroxyalkanoate (PHA) is a sealant layer of the top membrane, and said film comprises at least 30% in weight PHA.

4. A capsule according to claim 1, wherein the top membrane has a material thickness in the range of about 120 to 150 μm.

5. A capsule according to claim 1, wherein at least the portion of the top membrane adapted to be punctured for liquid injection presents:
a tensile strength higher than 1 MPa, and
an elongation at break superior to 100%.

6. A capsule according to claim 1, wherein said top membrane is a multilayer film and said multilayer film comprises at least:
a first layer film of PHA blended with one or more biopolymers, and
a second layer film of at least one polybutylene succinate.

7. A capsule according to claim 6, wherein said multilayer film comprises a bottom layer film, said bottom layer being configured to be sealed to at least a part of the upper surface of the circumferential flange of the capsule body, and wherein bottom layer film is different from the second layer film of at least one polybutylene succinate (PBS).

8. A capsule according to claim 6, wherein the top membrane is manufactured by a process comprising a step of co-extruding the two layer films, and comprising a step of laminating a print layer and/or a step of laminating a water vapor transmission barrier layer.

9. A capsule according to claim 1, wherein the capsule body is made of biodegradable materials.

10. System of a capsule for use in a beverage preparation machine, said capsule containing a soluble and/or extractable beverage ingredient and said capsule comprising:
a capsule body comprising:
a side wall defining a chamber and extending axially between a top opening and a bottom outlet,
a circumferential annular flange projecting radially outward from the top opening, said flange comprising an upper surface opposite to the chamber with respect to the opening and an opposed lower surface,
and
a top membrane attached to at least a part of the upper surface of the circumferential flange, said top membrane closing the top opening, and presenting a portion adapted to be punctured for liquid injection into the capsule,
a bottom membrane provided inside the chamber so as to delimit an ingredient chamber between the top membrane and said bottom membrane, said ingredient chamber containing a beverage ingredient,
an opening device provided inside the chamber for opening the capsule by relative engagement of said opening device with the bottom membrane under the effect of a rise in pressure of the injected liquid in the ingredient chamber, and
wherein the top membrane is biodegradable and comprises at least one film of a at least one polyhydroxyalkanoate (PHA) and a beverage preparation machine, said machine comprising a liquid injection hollow needle to inject an extraction liquid under pressure inside or into the chamber

11. System according to claim 9, wherein the beverage preparation machine comprises:
a capsule holder for receiving and holding the capsule in the beverage preparation machine,
a capsule holder receiving area for inserting the removable capsule holder, and
wherein the liquid injection hollow needle and the inserted capsule holder are relatively moveable one to the other so that the liquid injection hollow needle punctures the top membrane of the capsule.

12. (canceled)
